(19) United States
(12) Patent Application Publication
(10) Pub. No.: US 2025/0211904 A1
(43) Pub. Date: Jun. 26, 2025

(54) AUDIO SIGNAL CAPTURE

(71) Applicant: Nokia Technologies Oy, Espoo (FI)

(72) Inventors: Lasse Juhani LAAKSONEN, Tampere (FI); Tapani PIHLAJAKUJA, Espoo (FI); Arto Juhani LEHTINIEMI, Tampere (FI)

(21) Appl. No.: 18/971,919

(22) Filed: Dec. 6, 2024

(30) Foreign Application Priority Data
Dec. 22, 2023 (GB) 2319892.2

(51) Int. Cl. H04R 5/027; H04R 3/12; H04R 5/02

(52) U.S. Cl. CPC H04R 5/027; H04R 3/12; H04R 5/02; H04R 2203/12

(57) ABSTRACT

Example embodiments relate to an apparatus, method and computer program for audio signal capture. The method may for example comprise receiving audio data representing audio signals for output by two or more physical loudspeakers, and determining that at least some of the audio signals, representing a first sound source, are for output by two or more particular physical loudspeakers such that the first sound source will be perceived as having a first direction with respect to a user which is other than a physical loudspeaker direction. The method may for example also comprise, responsive to the determining, transmitting control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

### FIELD

Example embodiments relate to audio signal capture, for example in situations where an audio capture device captures audio signals which are output, or are intended to be output, using two or more physical loudspeakers.

### BACKGROUND

Certain audio signal formats are suited to output by two or more physical loudspeakers. Such audio signal formats may include stereo, multichannel and immersive formats. By output of audio signals using two or more physical loudspeakers, listening users may perceive one or more sound objects as coming from a particular direction which is other than a direction of a physical loudspeaker.

Users who wear certain audio capture devices when listening to audio signals output by two or more physical loudspeakers may not get an optimum user experience.

### SUMMARY OF THE INVENTION

The scope of protection sought for various embodiments of the invention is set out by the independent claims. The embodiments and features, if any, described in this specification that do not fall under the scope of the independent claims are to be interpreted as examples useful for understanding various embodiments of the invention.

A first aspect provides an apparatus comprising: means for receiving audio data representing audio signals for output by two or more physical loudspeakers; means for determining that at least some of the audio signals, representing a first sound source, are for output by two or more particular physical loudspeakers such that the first sound source will be perceived as having a first direction with respect to a user which is other than a physical loudspeaker direction; and means for, responsive to the determining, transmitting control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

In some example embodiments, the apparatus may further comprise: means for receiving a notification message from the audio capture device for indicating that the audio capture device is operating in the directivity mode, wherein the control data is transmitted to the audio capture device in further response to receiving the notification message.

In some example embodiments, the control data may be for causing the audio capture device to widen the sound capture beam such that it has greater sensitivity to audio signals from a wider range of directions with respect to the user, including the direction of the at least one of the two or more particular physical loudspeakers.

In some example embodiments, the control data may be for causing the audio capture device to widen the sound capture beam such that it has greater sensitivity to audio signals from respective directions of the two or more particular physical loudspeakers.

In some example embodiments, the control data may be for causing the audio capture device to steer the sound capture beam from the first direction to the direction of one of the two or more particular physical loudspeakers.

In some example embodiments, the control data may comprise data indicative of a spatial position of at least one of the two or more particular physical loudspeakers for enabling the audio capture device to estimate the direction or respective directions of the at least one of the two or more particular physical loudspeakers.

In some example embodiments, the apparatus may further comprise: means for receiving, from the audio capture device, position data indicative of its spatial position and direction of the sound capture beam; and means for determining a modification to apply to the sound capture beam of the audio capture device using the position data and known position(s) of the at least one of the two or more particular physical loudspeakers, wherein the control data comprises the determined modification to be applied by the audio capture device.

In some example embodiments, the modification may comprise an amount to widen the sound capture beam.

In some example embodiments, the modification may comprise a direction and amount to steer the sound capture beam from the first direction to the direction of the one of the two or more particular physical loudspeakers.

In some example embodiments, the apparatus may further comprise: means for receiving spatial metadata associated with the audio data, the spatial metadata indicating spatial characteristics of an audio scene which comprises at least the first sound source, wherein the means for determining is configured to determine from the spatial metadata that the first sound source will be perceived as having said first direction with respect to the user which is other than a physical loudspeaker direction.

In some example embodiments, the audio data and spatial metadata may be received in an Immersive Voice and Audio Services, IVAS, bitstream.

In some example embodiments, the IVAS bitstream may be provided in a data format comprising one of: Metadata-Assisted Spatial Audio, MASA; Objects with Metadata-Assisted Spatial Audio, OMASA; and Independent Streams with Metadata, ISM.

In some example embodiments, the apparatus may further comprise: means for identifying, responsive to detecting that the audio data and spatial metadata is received in an IVAS bitstream, that one or more of the MASA, OMASA and ISM data formats is or are supported by the IVAS bitstream; and means for selecting one, or a preferential order, of the MASA, OMASA and ISM data formats for decoding of the IVAS bitstream and obtaining the spatial metadata.

In some example embodiments, the apparatus may comprise a mobile terminal.

A second aspect provides an apparatus comprising: means for capturing audio signals output by two or more physical loudspeakers, including audio signals representing a first sound source output by two or more particular physical loudspeakers such that the first sound source will be perceived as having a first direction with respect to a user which is other than a physical loudspeaker direction; means for operating in a directivity mode for steering a sound capture beam towards the first direction; and means for receiving control data from a control device, wherein the control data causes disabling of the directivity mode or modifying of the sound capture beam such that the apparatus has greater sensitivity to audio signals from the direction of at least one of the two or more particular physical loudspeakers.

In some example embodiments, the apparatus may further comprise: means for transmitting a notification message to the control device for indicating that the apparatus is operating in the directivity mode, wherein the control data is received from the control device in response to transmitting the notification message.

In some example embodiments, the control data may causes widening of the sound capture beam such that it has greater sensitivity to audio signals from a wider range of directions, including the direction of the at least one of the two or more particular physical loudspeakers.

In some example embodiments, the control data nay cause widening of the sound capture beam such that it has greater sensitivity to audio signals from respective directions of the two or more particular physical loudspeakers.

In some example embodiments, the control data may cause the sound capture beam to be steered from the first direction to the direction of one of the two or more particular physical loudspeakers.

In some example embodiments, the control data may comprise data indicative of a spatial position of the at least one of the two or more physical loudspeakers, and the apparatus may further comprise means for estimating the direction or respective directions of the at least one of the two or more particular physical loudspeakers.

In some example embodiments, the apparatus may further comprise: means for transmitting, to the control device, position data indicative of a spatial position of the apparatus and the direction of the sound capture beam, wherein the control data comprises a determined modification to apply to the sound capture beam based on the position data and known position(s) of the at least one of the two or more particular physical loudspeakers.

In some example embodiments, the modification may comprise an amount to widen the sound capture beam.

In some example embodiments, the modification may comprise a direction and amount to steer the sound capture beam from the first direction to the direction of the one of the two or more particular physical loudspeakers.

In some example embodiments, the apparatus may comprise a head or ear-worn user device.

A third aspect provides an apparatus comprising: means for receiving audio data representing audio signals for output by two or more physical loudspeakers; means for determining that: at least some of the audio signals, representing a first sound source, are for output by two or more particular physical loudspeakers such that the first sound source will be perceived as having a first direction with respect to a user which is other than a physical loudspeaker direction; an audio capture device of the user operates in a directivity mode for steering a sound capture beam towards the first direction, and means for, responsive to the determining, rendering said at least some audio signals of the first sound source from a selected one of the two or more particular physical loudspeakers and not from the other particular physical loudspeaker(s) such that the first sound source will be perceived from the direction of the selected physical loudspeaker thereby to cause the sound capture beam of the audio capture device to be steered towards the selected physical loudspeaker.

A fourth aspect provides an apparatus comprising: means for receiving audio data representing audio signals for output by two or more physical loudspeakers; means for determining that: at least some of the audio signals, representing a first sound source, are for output by two or more particular physical loudspeakers such that the first sound source will be perceived as having a first direction with respect to a user which is other than a physical loudspeaker direction; an audio capture device of the user operates in a directivity mode for steering a sound capture beam towards the first direction; means for receiving a notification message from the audio capture device indicative that one or more other, real-world sound sources, are captured by the sound capture beam; and means for, responsive to receiving the notification message, rendering said at least some audio signals of the first sound source such that the first sound source will be perceived as having a second direction with respect to the user which is different from the first direction.

A fifth aspect provides a method comprising: receiving audio data representing audio signals for output by two or more physical loudspeakers; determining that at least some of the audio signals, representing a first sound source, are for output by two or more particular physical loudspeakers such that the first sound source will be perceived as having a first direction with respect to a user which is other than a physical loudspeaker direction; and, responsive to the determining, transmitting control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

In some example embodiments, the method may further comprise: receiving a notification message from the audio capture device for indicating that the audio capture device is operating in the directivity mode, wherein the control data is transmitted to the audio capture device in further response to receiving the notification message.

In some example embodiments, the control data may be for causing the audio capture device to widen the sound capture beam such that it has greater sensitivity to audio signals from a wider range of directions with respect to the user, including the direction of the at least one of the two or more particular physical loudspeakers.

In some example embodiments, the control data may be for causing the audio capture device to widen the sound capture beam such that it has greater sensitivity to audio signals from respective directions of the two or more particular physical loudspeakers.

In some example embodiments, the control data may be for causing the audio capture device to steer the sound capture beam from the first direction to the direction of one of the two or more particular physical loudspeakers.

In some example embodiments, the control data may comprise data indicative of a spatial position of at least one of the two or more particular physical loudspeakers for enabling the audio capture device to estimate the direction or respective directions of the at least one of the two or more particular physical loudspeakers.

In some example embodiments, the method may further comprise: receiving, from the audio capture device, position data indicative of its spatial position and direction of the sound capture beam; and determining a modification to apply to the sound capture beam of the audio capture device using the position data and known position(s) of the at least one of the two or more particular physical loudspeakers, wherein the control data comprises the determined modification to be applied by the audio capture device.

In some example embodiments, the modification may comprise an amount to widen the sound capture beam.

In some example embodiments, the modification may comprise a direction and amount to steer the sound capture beam from the first direction to the direction of the one of the two or more particular physical loudspeakers.

In some example embodiments, the method may further comprise: means receiving spatial metadata associated with the audio data, the spatial metadata indicating spatial characteristics of an audio scene which comprises at least the first sound source, wherein it is determined from the spatial metadata that the first sound source will be perceived as having said first direction with respect to the user which is other than a physical loudspeaker direction.

In some example embodiments, the audio data and spatial metadata may be received in an Immersive Voice and Audio Services, IVAS, bitstream.

In some example embodiments, the IVAS bitstream may be provided in a data format comprising one of: Metadata-Assisted Spatial Audio, MASA; Objects with Metadata-Assisted Spatial Audio, OMASA; and Independent Streams with Metadata, ISM.

In some example embodiments, the method may further comprise: identifying, responsive to detecting that the audio data and spatial metadata is received in an IVAS bitstream, that one or more of the MASA, OMASA and ISM data formats is or are supported by the IVAS bitstream; and selecting one, or a preferential order, of the MASA, OMASA and ISM data formats for decoding of the IVAS bitstream and obtaining the spatial metadata.

In some example embodiments, the method may be performed at a mobile terminal.

A sixth aspect provides a method comprising: capturing audio signals output by two or more physical loudspeakers, including audio signals representing a first sound source output by two or more particular physical loudspeakers such that the first sound source will be perceived as having a first direction with respect to a user which is other than a physical loudspeaker direction; operating in a directivity mode for steering a sound capture beam towards the first direction; and receiving control data from a control device, wherein the control data causes disabling of the directivity mode or modifying of the sound capture beam such that the apparatus has greater sensitivity to audio signals from the direction of at least one of the two or more particular physical loudspeakers.

In some example embodiments, the method may further comprise: transmitting a notification message to the control device for indicating that the apparatus is operating in the directivity mode, wherein the control data is received from the control device in response to transmitting the notification message.

In some example embodiments, the control data may causes widening of the sound capture beam such that it has greater sensitivity to audio signals from a wider range of directions, including the direction of the at least one of the two or more particular physical loudspeakers.

In some example embodiments, the control data nay cause widening of the sound capture beam such that it has greater sensitivity to audio signals from respective directions of the two or more particular physical loudspeakers.

In some example embodiments, the control data may cause the sound capture beam to be steered from the first direction to the direction of one of the two or more particular physical loudspeakers.

In some example embodiments, the control data may comprise data indicative of a spatial position of the at least one of the two or more physical loudspeakers, and the method may further comprise estimating the direction or respective directions of the at least one of the two or more particular physical loudspeakers.

In some example embodiments, the method may further comprise: transmitting, to the control device, position data indicative of a spatial position and the direction of the sound capture beam, wherein the control data comprises a determined modification to apply to the sound capture beam based on the position data and known position(s) of the at least one of the two or more particular physical loudspeakers.

In some example embodiments, the modification may comprise an amount to widen the sound capture beam.

In some example embodiments, the modification may comprise a direction and amount to steer the sound capture beam from the first direction to the direction of the one of the two or more particular physical loudspeakers.

In some example embodiments, the method may be performed by a head or ear-worn user device.

A seventh aspect provides a method comprising: receiving audio data representing audio signals for output by two or more physical loudspeakers; determining that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; and, responsive to the determining, rendering said at least some audio signals of the first sound source from a selected one of the two or more particular physical loudspeakers and not from the other particular physical loudspeaker(s) such that the first sound source will be perceived from the direction of the selected physical loudspeaker thereby to cause the sound capture beam of the audio capture device to be steered towards the selected physical loudspeaker.

An eighth aspect provides a method comprising: receiving audio data representing audio signals for output by two or more physical loudspeakers; determining that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; receiving a notification message from the audio capture device indicative that one or more other, real-world sound sources, are captured by the sound capture beam; and, responsive to receiving the notification message, rendering said at least some audio signals of the first sound source such that the first sound source will be perceived as having a second direction with respect to the user which is different from the first direction.

A ninth aspect provides a computer program comprising a set of instructions which, when executed on an apparatus, is configured to cause the apparatus to carry out a method comprising: receiving audio data representing audio signals for output by two or more physical loudspeakers; determining that at least some of the audio signals, representing a first sound source, are for output by two or more particular physical loudspeakers such that the first sound source will be perceived as having a first direction with respect to a user which is other than a physical loudspeaker direction; and, responsive to the determining, transmitting control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

In some example embodiments, the ninth aspect may include any other feature mentioned with respect to the method of the fifth aspect.

A tenth aspect provides a computer program comprising a set of instructions which, when executed on an apparatus, is configured to cause the apparatus to carry out a method comprising: capturing audio signals output by two or more physical loudspeakers, including audio signals representing a first sound source output by two or more particular physical loudspeakers such that the first sound source will be perceived as having a first direction with respect to a user which is other than a physical loudspeaker direction; operating in a directivity mode for steering a sound capture beam towards the first direction; and receiving control data from a control device, wherein the control data causes disabling of the directivity mode or modifying of the sound capture beam such that the apparatus has greater sensitivity to audio signals from the direction of at least one of the two or more particular physical loudspeakers.

In some example embodiments, the tenth aspect may include any other feature mentioned with respect to the method of the sixth aspect.

An eleventh aspect provides a computer program comprising a set of instructions which, when executed on an apparatus, is configured to cause the apparatus to carry out a method comprising: receiving audio data representing audio signals for output by two or more physical loudspeakers; determining that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; and, responsive to the determining, rendering said at least some audio signals of the first sound source from a selected one of the two or more particular physical loudspeakers and not from the other particular physical loudspeaker(s) such that the first sound source will be perceived from the direction of the selected physical loudspeaker thereby to cause the sound capture beam of the audio capture device to be steered towards the selected physical loudspeaker.

A twelfth aspect provides a computer program comprising a set of instructions which, when executed on an apparatus, is configured to cause the apparatus to carry out a method comprising: receiving audio data representing audio signals for output by two or more physical loudspeakers; determining that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; receiving a notification message from the audio capture device indicative that one or more other, real-world sound sources, are captured by the sound capture beam; and, responsive to receiving the notification message, rendering said at least some audio signals of the first sound source such that the first sound source will be perceived as having a second direction with respect to the user which is different from the first direction.

A thirteenth aspect of the invention provides a non-transitory computer-readable medium having stored thereon computer-readable code, which, when executed by at least one processor, causes the at least one processor to perform a method, comprising: receiving audio data representing audio signals for output by two or more physical loudspeakers; determining that at least some of the audio signals, representing a first sound source, are for output by two or more particular physical loudspeakers such that the first sound source will be perceived as having a first direction with respect to a user which is other than a physical loudspeaker direction; and, responsive to the determining, transmitting control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

In some example embodiments, the thirteenth aspect may include any other feature mentioned with respect to the method of the fifth aspect.

A fourteenth aspect of the invention provides a non-transitory computer-readable medium having stored thereon computer-readable code, which, when executed by at least one processor, causes the at least one processor to perform a method, comprising: capturing audio signals output by two or more physical loudspeakers, including audio signals representing a first sound source output by two or more particular physical loudspeakers such that the first sound source will be perceived as having a first direction with respect to a user which is other than a physical loudspeaker direction; operating in a directivity mode for steering a sound capture beam towards the first direction; and receiving control data from a control device, wherein the control data causes disabling of the directivity mode or modifying of the sound capture beam such that the apparatus has greater sensitivity to audio signals from the direction of at least one of the two or more particular physical loudspeakers.

In some example embodiments, the fourteenth aspect may include any other feature mentioned with respect to the method of the sixth aspect.

A fifteenth aspect of the invention provides a non-transitory computer-readable medium having stored thereon computer-readable code, which, when executed by at least one processor, causes the at least one processor to perform a method, comprising: receiving audio data representing audio signals for output by two or more physical loudspeakers; determining that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; and, responsive to the determining, rendering said at least some audio signals of the first sound source from a selected one of the two or more particular physical loudspeakers and not from the other particular physical loudspeaker(s) such that the first sound source will be perceived from the direction of the selected physical loudspeaker thereby to cause the sound capture beam of the audio capture device to be steered towards the selected physical loudspeaker.

A sixteenth aspect of the invention provides a non-transitory computer-readable medium having stored thereon computer-readable code, which, when executed by at least one processor, causes the at least one processor to perform a method, comprising: receiving audio data representing audio signals for output by two or more physical loudspeakers; determining that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; receiving a notification message from the audio capture device indicative that one or more other, real-world sound sources, are captured by the sound capture beam; and, responsive to receiving the notification message, rendering said at least some audio signals of the first sound source such that the first sound source will be perceived as having a second direction with respect to the user which is different from the first direction.

A seventeenth aspect of the invention provides an apparatus, the apparatus having at least one processor and at least one memory having computer-readable code stored thereon which when executed controls the at least one processor to: receive audio data representing audio signals for output by two or more physical loudspeakers; determine that at least some of the audio signals, representing a first sound source, are for output by two or more particular physical loudspeakers such that the first sound source will be perceived as having a first direction with respect to a user which is other than a physical loudspeaker direction; and, responsive to the determining, transmit control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

In some example embodiments, the seventeenth aspect may include any other feature mentioned with respect to the method of the fifth aspect.

An eighteenth aspect of the invention provides an apparatus, the apparatus having at least one processor and at least one memory having computer-readable code stored thereon which when executed controls the at least one processor to: capture audio signals output by two or more physical loudspeakers, including audio signals representing a first sound source output by two or more particular physical loudspeakers such that the first sound source will be perceived as having a first direction with respect to a user which is other than a physical loudspeaker direction; operate in a directivity mode for steering a sound capture beam towards the first direction; and receive control data from a control device, wherein the control data causes disabling of the directivity mode or modifying of the sound capture beam such that the apparatus has greater sensitivity to audio signals from the direction of at least one of the two or more particular physical loudspeakers.

In some example embodiments, the eighteenth aspect may include any other feature mentioned with respect to the method of the sixth aspect.

A nineteenth aspect of the invention provides an apparatus, the apparatus having at least one processor and at least one memory having computer-readable code stored thereon which when executed controls the at least one processor to: receive audio data representing audio signals for output by two or more physical loudspeakers; determine that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; and, responsive to the determining, render said at least some audio signals of the first sound source from a selected one of the two or more particular physical loudspeakers and not from the other particular physical loudspeaker(s) such that the first sound source will be perceived from the direction of the selected physical loudspeaker thereby to cause the sound capture beam of the audio capture device to be steered towards the selected physical loudspeaker.

A twentieth aspect of the invention provides an apparatus, the apparatus having at least one processor and at least one memory having computer-readable code stored thereon which when executed controls the at least one processor to: receive audio data representing audio signals for output by two or more physical loudspeakers; determine that: at least some of the audio signals, representing a first sound source, are for output by two or more particular physical loudspeakers such that the first sound source will be perceived as having a first direction with respect to a user which is other than a physical loudspeaker direction and an audio capture device of the user operates in a directivity mode for steering a sound capture beam towards the first direction; receive a notification message from the audio capture device indicative that one or more other, real-world sound sources, are captured by the sound capture beam; and, responsive to receiving the notification message, render said at least some audio signals of the first sound source such that the first sound source will be perceived as having a second direction with respect to the user which is different from the first direction.

### BRIEF DESCRIPTION OF THE DRAWINGS

The invention will now be described, by way of non-limiting example, with reference to the accompanying drawings, in which:

FIG. 1 illustrates a system for audio rendering;

FIG. 2 illustrates the FIG. 1 system with an indication of a sound source direction;

FIG. 3 illustrates an audio capture device;

FIG. 4 is a flow diagram showing operations according to one or more example embodiments;

FIG. 5 illustrates a system for audio rendering which may be useful for understanding one or more example embodiments;

FIG. 6 illustrates a system for audio rendering according to one or more example embodiments;

FIG. 7 illustrates a system for audio rendering according to one or more other example embodiments;

FIG. 8 illustrates a system for audio rendering according to one or more other example embodiments;

FIG. 9 is a flow diagram showing operations according to another example embodiment;

FIG. 10 is a flow diagram showing operations according to another example embodiment;

FIG. 11 illustrates a system for audio rendering according to another example embodiment;

FIG. 12 is a flow diagram showing operations according to another example embodiment;

FIG. 13 illustrates an audio field which may be useful for understanding one or more other example embodiments;

FIG. 14 illustrates the FIG. 13 audio field when modified according to one or more other example embodiments;

FIG. 15 is a block diagram of an apparatus that may be configured in accordance with one or more example embodiments; and

FIG. 16 is a non-transitory computer readable medium in accordance with one or more example embodiments.

### DETAILED DESCRIPTION

Example embodiments relate to audio signal capture, for example in situations where an audio capture device may capture audio signals which are output, or are intended to be output, using two or more physical loudspeakers.

Example embodiments focus on immersive audio but it should be appreciated that other audio formats for output by two or more physical loudspeakers, including, but not limited to, stereo and multi-channel audio formats, are also applicable.

Immersive audio in this context may refer to any technology which renders sound objects in a space such that listening users in that space may perceive one or more sound objects as coming from respective direction(s) in the space. Users may also perceive a sense of depth.

Immersive audio in this context may include any technology, such as surround sound and different types of spatial audio technology, that utilise two or more physical loudspeakers having respective spaced-apart positions to provide an immersive audio experience. 3GPP Immersive Voice and Audio Services (IVAS) and MPEG-I Audio are example immersive audio formats or codecs, but example embodiments are not limited to such examples.

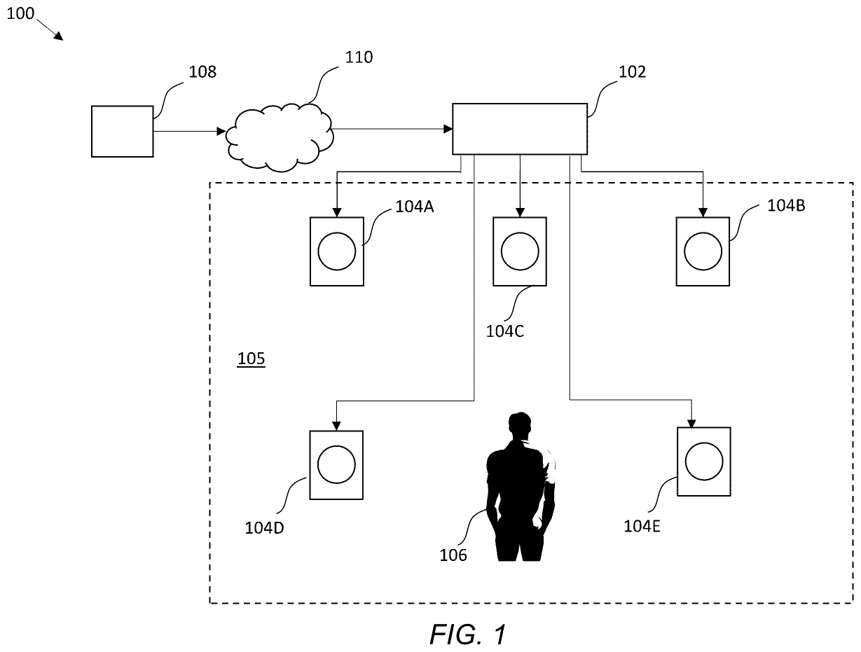

FIG. 1 shows a system 100 for output of immersive audio, the system comprising an audio processor 102 (sometimes referred to as an audio receiver or audio amplifier) and first to fifth physical loudspeakers 104A-104E (hereafter “loudspeakers”) which are spaced-apart and have respective positions in a listening space 105 which may be a room. The first, second and third loudspeakers 104A, 104B, 104C may be termed front-left, front-right and front-centre loudspeakers based on their respective positions with respect to a typical listening position, indicated by reference numeral 106. Similarly, the fourth and fifth loudspeakers 104D, 104E may be termed rear-left and rear-right loudspeakers based on their respective positions with respect to said listening position 106. There may also be a further loudspeaker, not shown, for output of lower frequency audio signals and this may be known as a sub-woofer, bass speaker or similar. In some example embodiments, there may be fewer loudspeakers. The system 100 may therefore represent a 5.1 surround sound set-up but it will be appreciated that there are numerous other set-ups such as, but not limited to, 2.0, 2.1, 3.1, 4.0, 4.1, 5.1, 5.1.2, 5.1.4, 6.1, 7.1, 7.1.2, 7.1.4, 7.2, 9.1, 9.1.2, 10.2, 13.1 and 22.2.

The audio processor 102 may be configured to store audio data representing immersive audio content for output via all or particular ones of the first to fifth loudspeakers 104A-104E. The audio processor 102 may comprise amplifiers, signal processing functions, one or more memories, e.g., a hard disk drive (HDD) and/or a solid state drive (SSD) for storing audio data. The audio processor 102 may be provided in any suitable form, such as a set-top box, a mobile terminal such as a mobile phone, a tablet computer, or similar. The audio processor 102 may be a digital-only processor in which case it may not comprise amplifiers. For example, the audio data may be received from a remote source 108 over a network 110 and stored on the one or more memories. The network 110 may comprise the Internet. The audio data may be received via a wired or wireless connection to the network 110 such as via a home router or hub. Alternatively, the audio data may be streamed from the remote source 108 using a suitable streaming protocol, e.g., the real-time streaming protocol (RTSP) or similar. Alternatively, audio data may be provided on a non-transitory computer-readable medium such as an optical disk, memory card, memory stick or removable hard drive which is inserted, or connected, to a suitable part of the audio processor 102.

The audio data may represent audio signals for any form of audio, whether speech, singing, music, ambience or a combination thereof. The audio data may comprise data which is part of a voice call or conference. The audio data may be associated with video data, for example as part of a videocall, video conference, video clip, video game or movie. The audio data may represent an audio scene comprising one or more sound objects.

The audio processor 102 may be configured to render the audio data by output of audio signals using particular ones of the first to fifth loudspeakers 104A-104E. The audio processor 102 may therefore comprise hardware, software and/or firmware configured to process and output (or render) the audio signals to said particular ones of the first to fifth loudspeakers 104A-104E. The audio processor 102 may also provide other signal processing functionality such as to modify overall volume, modify respective volumes for different frequency ranges and/or perform certain effects, such as to modify reverberation and/or perform panning such as Vector Base Amplitude Panning (VBAP). VBAP is a method for positioning sound sources to arbitrary directions using the current loudspeaker setup; the number of loudspeakers is arbitrary as they can be positioned in 2 or 3-dimensional setups. VBAP produces virtual sources that are localized to a relatively narrow region. VBAP processing may involve finding a loudspeaker triplet, i.e., three loudspeakers, enclosing a desired sound source panning position, and then calculating gains to be applied to audio signals for said sound source such that it will be reproduced using the three loudspeakers. The audio processor 102 may for example implement VBAP. An alternative method is Speaker-Placement Correction Amplitude Panning (SPCAP). Another alternative method is Edge Fading Amplitude Panning (EFAP).

The audio data may include metadata or other computer-readable indications which the audio processor 102 processes to determine how the audio signals are to be rendered, for example by which of the first to fifth loudspeakers 104A-104E and in which signal proportions. For example, where the audio format is a IVAS bitstream, or similar, the audio data may have associated spatial metadata. The spatial metadata may indicate spatial characteristics of an audio scene, for example by indicating direction and direct-to-total ratio parameters which together control how much signal energy is to be reproduced by particular ones of the first to fifth loudspeakers 104A-104E. The spatial metadata may also indicate parameters such as spread coherence, diffuse-to-total energy ratio, surround coherence and remainder-to-total energy ratio. For example, a sound with a direction pointing to the front with a direct-to-total ratio of “1” will be reproduced only from the front, i.e., the third loudspeaker 104C, whereas if the direct-to-total ratio were “0” then the sound will be reproduced diffusely from each of the first to fifth loudspeakers 104A-104E.

In such cases, the IVAS bitstream may have a specific format including, but not limited to, Metadata-Assisted Spatial Audio, MASA, Objects with Metadata-Assisted Spatial Audio, OMASA and/or Independent Streams with Metadata, ISM. The audio processor 102 may, in some cases, determine which audio format to decode by negotiating with the remote source 108. The remote source 108 may indicate in initial data which audio formats are supported in the IVAS bitstream and the audio processor 102 may then select one or more of the audio formats to use, e.g., in a preferred order, possibly based on the availability of its own decoders for such formats, and therefore configures its decoding functionality.

The audio signals may be arranged into channels, e.g., one for each of the first to fifth loudspeakers 104A-104E.

In some cases, only a subset of the first to fifth loudspeakers 104A-104E may be used based on the metadata or other computer-readable indications.

The audio processor 102, by output of audio signals from two or more particular ones of the first to fifth loudspeakers 104A-104E, may render a sound source so that it will be perceived by a user as coming from a direction with respect to that user which is other than the direction of (any of) the first to fifth loudspeakers. This may be termed a phantom sound source.

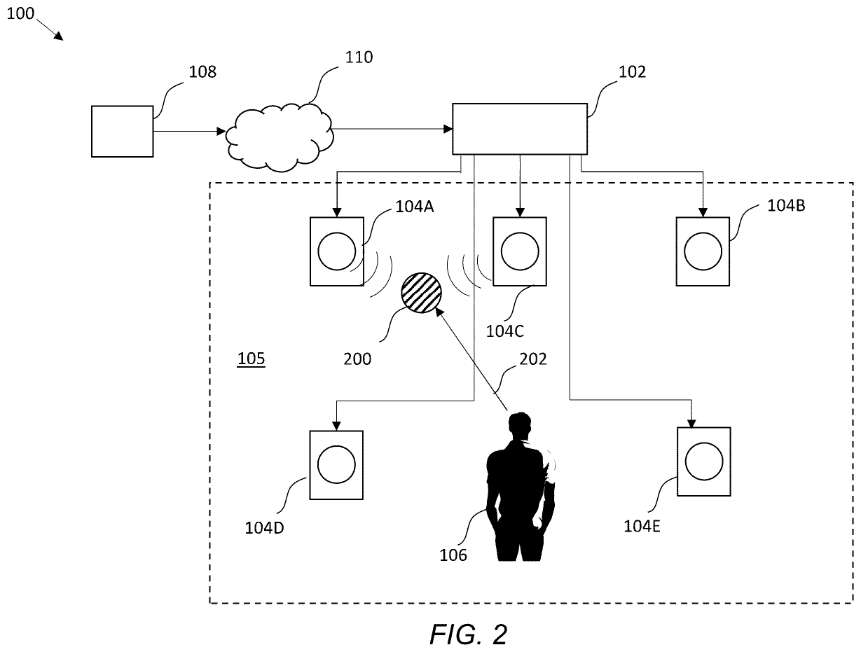

FIG. 2 shows the FIG. 1 system with a first sound source 200 indicated at a position between the first and third loudspeakers 104A, 104C such that it will be perceived by the user at position 106 as coming from a first direction 202 with respect to that user. The first sound source 200 is an example of a phantom sound source.

In this example, the audio processor 102 may render the first sound source 200 using the first and third loudspeakers 104A, 104C.

The same process may be performed for one or more other sound sources, not shown, such that that they will be perceived by the user as coming from respective directions with respect to the user position 106.

Users who wear certain audio capture devices may not get an optimum user experience when experiencing immersive audio, e.g., as in FIG. 2. This is particularly the case for audio capture devices such as hearing aids or earphone devices operable in a directivity, or accessibility mode for hearing assistance. In this context, such audio capture devices may not only capture sounds, but also process and reproduce the captured sounds.

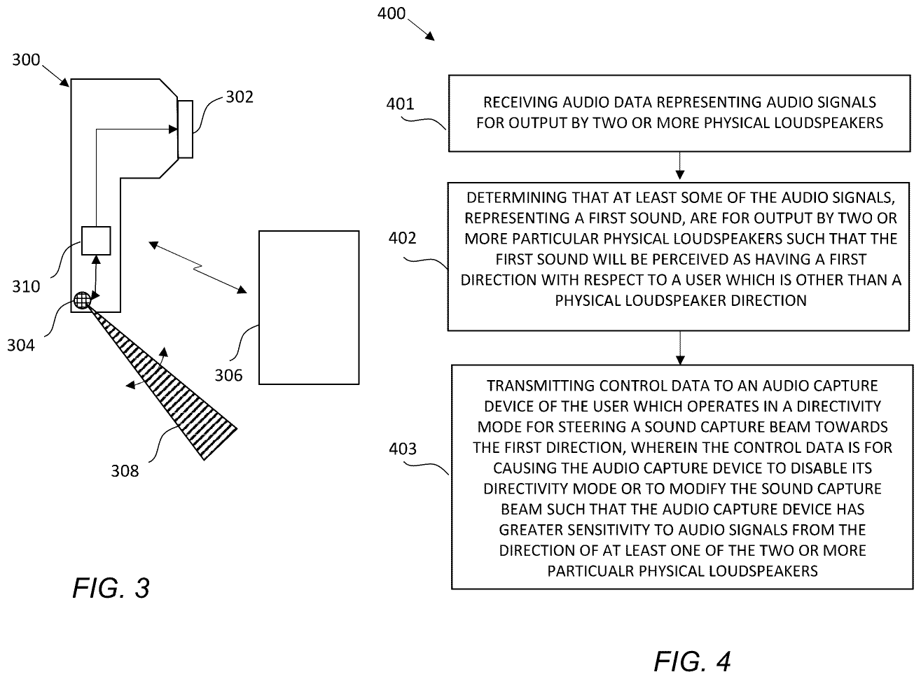

FIG. 3 is a schematic view of an example audio capture device, comprising an earphone 300. In other examples, the audio capture device may comprise any ear or head-worn device comprising one or more microphones and one or more loudspeakers, such as a beamforming hearing aid. Although not shown, the earphone 300 may comprise one of a pair of earphones. The earphone 300 may comprise a loudspeaker 302 which, in use, is to be placed over or within a user's ear, and a microphone array 304. The earphone 300 may be configured in use to provide hearing assistance when operating in a so-called directivity (or accessibility) mode, which may be a default mode, or one which is enabled by means of a control input to the earphone or through another device, such as a user device 306 in paired communication with the earphone.

In some example embodiments, the user device 306 may comprise the audio processor 102 shown in FIG. 1. The control input may be provided by any suitable means, e.g., a touch input, a gesture, or a voice input.

The microphone array 304 may be configured to steer a sound capture beam 308 towards the perceived direction of particular sounds, such as particular sound objects or towards a direction relative to the earphone such as frontal direction.

More specifically, the earphone 300 may comprise a signal processing function 310 which spatially filters the surrounding audio field such that sounds coming from one or more particular directions (which one or more directions may adaptively change) or from within a predetermined range of direction(s), are amplified over sounds from other directions. In other words, the earphone 300 (or rather its microphone array 304) is more sensitive to sounds coming from the one or more particular directions, or the range of directions, than sounds outside of the one or more particular directions or range of directions. These directions effectively form the referred-to sound capture beam 308 which is useful for visualizing the sensitivity of the microphone array 304 at different times. It will be seen that the direction of the sound capture beam 308 can be steered under the control of the signal processing function 310 which amplifies and passes captured sounds within the sound capture beam to the loudspeaker 302.

The signal processing function 310 may be configured using known methods to widen the sound capture beam 308 and/or to steer the sound capture beam in a direction towards one or more particular sound objects or directions relative to the earphone 300.

The particular sound objects may comprise a predetermined type of sound object, such as a speech sound object and/or a sound object which is in a particular direction with respect to the earphone, e.g., towards its front side. The audio processor 102 may infer based on said predetermined type or respective direction of the sound object that it is of importance to the user.

Returning back to FIG. 2, if the user at position 106 is wearing an audio capture device operating in a directivity mode, e.g., the earphone 300, the sound capture beam 308 of FIG. 3 may be directed by the signal processing function 310 toward the first direction 202 because it is the perceived direction of the first sound source 200. However, amplification will likely be sub-optimal and may affect intelligibility of the first sound source 200. Amplification may be sub-optimal because the sound capture beam 308 is directed towards a location where there is no loudspeaker and attenuation may be performed on audio signals, e.g., the loudspeaker audio signals, outside of the sound capture beam. Also, the size and/or steering of the sound capture beam 308 by the signal processing function 310 may be affected. Overall, user experience may be negatively affected.

FIG. 4 is a flow diagram showing operations 400 that may be performed by one or more example embodiments. The operations 400 may be performed by hardware, software, firmware or a combination thereof. The operations 400 may be performed by one, or respective, means, a means being any suitable means such as one or more processors or controllers in combination with computer-readable instructions provided on one or more memories. The operations 400 may, for example, be performed by the audio processor 102 already described in relation to the FIG. 2 example.

A first operation 401 may comprise receiving audio data representing audio signals for output by two or more physical loudspeakers.

A second operation 402 may comprise determining that at least some of the audio signals, representing a first sound source, are for output by two or more particular physical loudspeakers such that the first sound source will be perceived as having a first direction with respect to a user which is other than a physical loudspeaker direction.

A third operation 403 may comprise, responsive to the determining, transmitting control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

In this way, an audio capture device operating in a directivity mode can be controlled such that the above-described issues are overcome or at least mitigated. The audio capture device may be configured to capture sounds and also to process and reproduce sounds for output via one or more loudspeakers of the audio capture device.

For ease of explanation, it will be assumed hereafter that the audio capture device comprises the earphone 300 and the control device comprises an audio processor, which may comprise part of a mobile phone or similar.

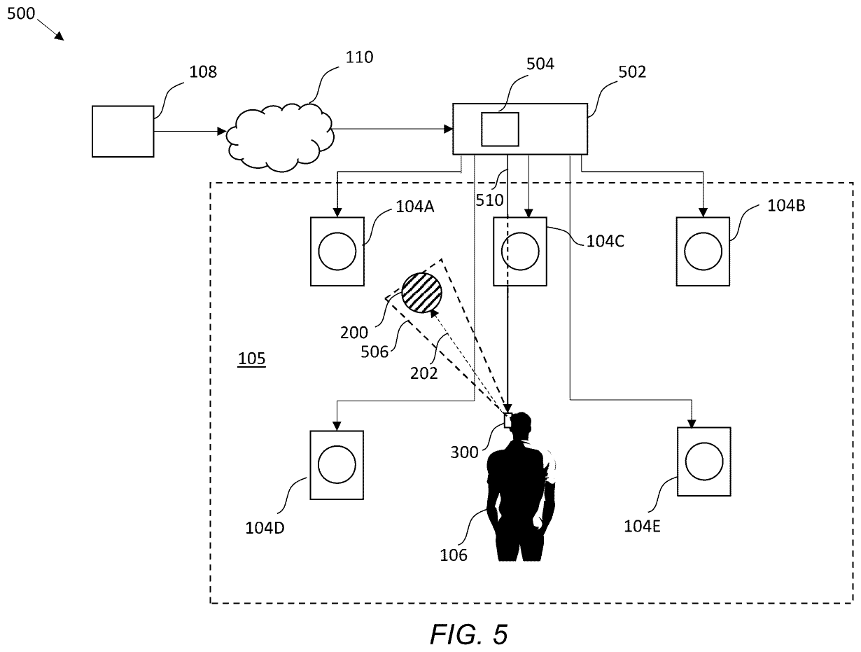

FIG. 5 shows a system 500 for output of immersive audio according to one or more example embodiments.

The system 500 is similar to that shown in FIG. 2. The system 500 comprises an audio processor 502 which includes a processing module 504 configured to perform the operations 400 described with reference to FIG. 4.

The processing module 504 may, in accordance with the first operation 401, receive the audio data from the remote source 108, for example in an immersive audio data format, e.g., the IVAS MASA format.

The processing module 504 may, in accordance with the second operation 402, determine that audio signals representing the first sound source 200 are output, or are to be output, from the first and third loudspeakers 104A, 104C as in FIG. 2. The processing module 504 may therefore determine that the first sound source 200 is, or is intended to be, perceived as coming from the first direction 202 with respect to the user at position 106. The determination may be based on spatial metadata, e.g., MASA spatial metadata, associated with the audio data.

The processing module 504 may then, in accordance with the third operation 403, transmit control data via a control channel 510 to the earphone 300.

As shown, the earphone 300 may be operating in a directivity mode for steering a sound capture beam 506 towards the first direction 202.

The fact that the earphone 300 is operating in the directivity mode may be unknown or known.

For example, the processing module 504 may transmit the control data to the earphone 300 without knowing that it is operating in the directivity mode. In this case, the control channel 510 may a broadcast channel. The same control data may also be received by one or more other audio capture devices in receiving range of the processing module 504 such that they will operate in the same way as the earphone 300.

In other examples, the processing module 504 may receive a notification message from the earphone 300 for indicating that the earphone is operating in the directivity mode. The notification message may be transmitted by the earphone 300 in response to a discovery signal transmitted (e.g., broadcast) by the processing module 504. Alternatively, the notification message may be transmitted by the earphone 300 in response to enablement of the directivity mode at the earphone. The processing module 504 may transmit the control data in further response to receiving the notification message. The control channel 510 may be a point-to-point channel.

Such signal communications between the audio processor 502 and the earphone 300 may be by means of any suitable wireless protocol, such as by WiFi, Bluetooth, Zigbee or any variant thereof. For example, there may be a paired relationship between the audio processor 502 and the earphone 300 which automatically establishes a link and performs signalling between said devices when the latter is in communication range of the former.

The control data may cause the earphone 300, or more specifically its signal processing function 310, to disable its directivity mode in which case the microphone array 304 becomes sensitive to sounds from all possible directions, thereby including the first and third loudspeakers 104A, 104C.

The control data may alternatively cause the earphone 300 (or more specifically its signal processing function 310) to modify the sound capture beam 506 such that the earphone 300 has greater sensitivity to audio signals from the direction of at least one of the first and third loudspeakers 104A, 104C.

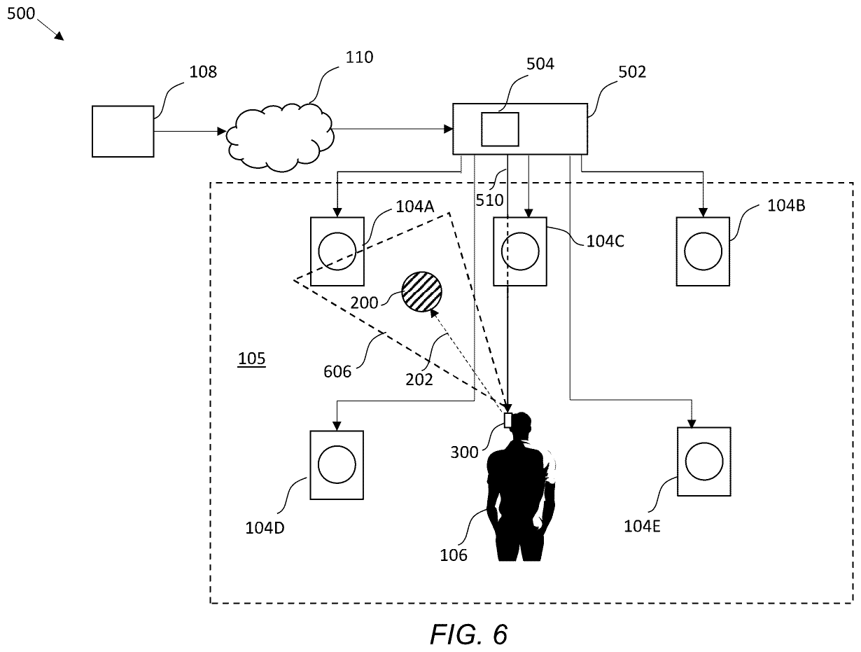

For example, as shown in FIG. 6, the control data may cause the earphone 300 to configure its signal processing function 310 to create a (spatially) wider sound capture beam 606. The wider sound capture beam 606 has, compared with the FIG. 5 case, greater sensitivity to audio signals from a wider range of directions, including the direction of, in this case, the first loudspeaker 104A.

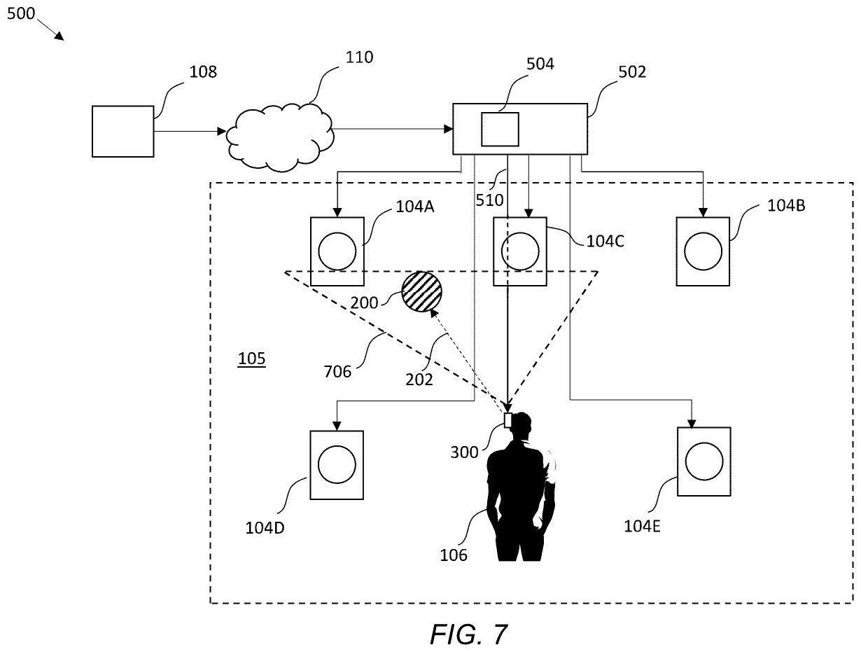

For example, as shown in FIG. 7, the control data may cause the earphone 300 to configure its signal processing function 310 to create a (spatially) wider sound capture beam 706 which includes the direction of both the first and third loudspeakers 104A, 104C.

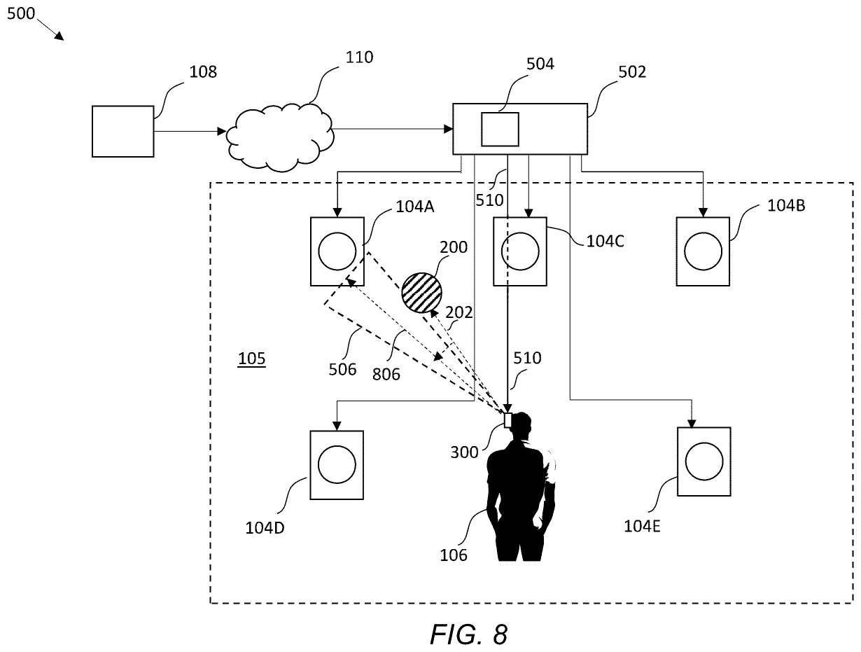

For example, as shown in FIG. 8, the control data may cause the earphone 300 to configure its signal processing function 310 to steer the sound capture beam 506 from the first direction 202 to a direction of one of the first and third loudspeakers 104A, 104C. In FIG. 8, the sound capture beam 506 is steered from the first direction 202 to a direction 806 of the first loudspeaker 104A. In other examples, the sound capture beam 506 may be steered from the first direction 202 to a direction of the third loudspeaker 104C.

In some example embodiments, the control data may comprise data indicative of the spatial position of at least one of the particular loudspeakers, in this case the spatial position of one or both of the first and third loudspeakers 104A, 104C.

The earphone 300 may estimate the direction or respective directions of the first and/or third loudspeakers 104A, 104C in order to modify the sound capture beam 506 in accordance with the above examples.

For example, the earphone 300 may determine its own spatial position (or, rather, the user's position 106) using known methods, such as by use of ranging signals transmitted from or to reference positions and multilateration processing. The earphone 300 knows that its sound capture beam 506 has a certain direction or orientation with respect to the user position 106.

The earphone 300 may then determine, using the spatial position of the first and/or third loudspeakers 104A, 104C with respect to its own position, how wide to modify the sound capture beam 506 such that the microphone array 304 has greater sensitivity in the directions of the first and/or third loudspeakers 104A, 104C.

In the case that the control data is for causing the earphone 300 to steer the sound capture beam 506 from the first direction 202 to the direction of one of the first and third loudspeakers 104A, 104C, then the earphone 300 may determine the direction and rotation amount required to steer the sound capture beam.

In some example embodiments, the processing module 504 may be configured to receive, from the earphone 300, position data indicative of the earphone's spatial position and the direction of the sound capture beam 506.

The processing module 504 may then determine a modification to apply to the sound capture beam 506 using the earphone's position data and direction of the sound capture beam.

For example, the processing module 504 may determine an amount to widen the sound capture beam 506 such that the microphone array 304 has greater sensitivity in the directions of the first and/or third loudspeakers 104A, 104C.

For example, the processing module 504 may determine a direction and rotation amount to steer the sound capture beam 506 from the first direction 202 to the direction of one of the first and third loudspeakers 104A, 104C.

The control data transmitted by the processing module 504 to the earphone 300 may comprise the determined modification to be applied by the earphone. Responsive to receiving the control data from the processing module 504, the earphone 300 may perform the determined modification.

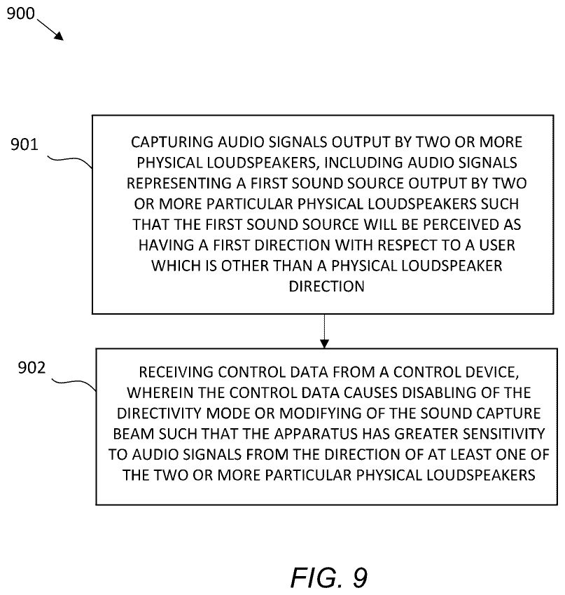

FIG. 9 is a flow diagram showing operations 900 that may be performed by one or more example embodiments. The operations 900 may be performed by hardware, software, firmware or a combination thereof. The operations 900 may be performed by one, or respective, means, a means being any suitable means such as one or more processors or controllers in combination with computer-readable instructions provided on one or more memories. The operations 900 may, for example, be performed by an audio capture device such as the earphone 300 already described in relation to the above examples.

A first operation 901 may comprise capturing audio signals output by two or more physical loudspeakers, including audio signals representing a first sound source output by two or more particular physical loudspeakers such that the first sound source will be perceived as having a first direction with respect to a user which is other than a physical loudspeaker direction.

Assuming a directivity mode is enabled for steering sound capture beam towards the first direction, a second operation 902 may comprise receiving control data from a control device, wherein the control data causes disabling of the directivity mode or modifying of the sound capture beam such that the apparatus has greater sensitivity to audio signals from the direction of at least one of the two or more particular physical loudspeakers.

As will be appreciated, the control device in the second operation 902 may comprise the audio processor 502 described in relation to FIGS. 5-8.

In some example embodiments, further operations may comprise transmitting a notification message to the control device for indicating that the apparatus is operating in the directivity mode, wherein the control data is received from the control device in response to transmitting the notification message.

In some example embodiments, the control data may cause widening of the sound capture beam such that it has greater sensitivity to audio signals from a wider range of directions, including the direction of the at least one of the two or more particular physical loudspeakers. For example, the control data may cause widening of the sound capture beam such that it has greater sensitivity to audio signals from respective directions of the two or more particular physical loudspeakers.

In some example embodiments, the control data may cause the sound capture beam to be steered from the first direction to the direction of one of the two or more particular physical loudspeakers.

In some example embodiments, the control data may comprise data indicative of a spatial position of the at least one of the two or more physical loudspeakers, and a further operation may comprise estimating the direction or respective directions of the at least one of the two or more particular physical loudspeakers.

In some example embodiments, a further operation may comprise transmitting, to the control device, position data indicative of a spatial position of the audio capture device and the direction of the sound capture beam, wherein the control data comprises a determined modification to apply to the sound capture beam based on the position data and known position(s) of the at least one of the two or more particular physical loudspeakers. The modification may comprise an amount to widen the sound capture beam. Alternatively, the modification may comprise a direction and amount to steer the sound capture beam from the first direction to the direction of the one of the two or more particular physical loudspeakers.

It will be appreciated from the above that by disabling the directivity mode or modifying the sound capture beam, a user of an audio capture device will have improved perception of sound sources.

Further embodiments will now be described, which may incorporate certain features and considerations described above.

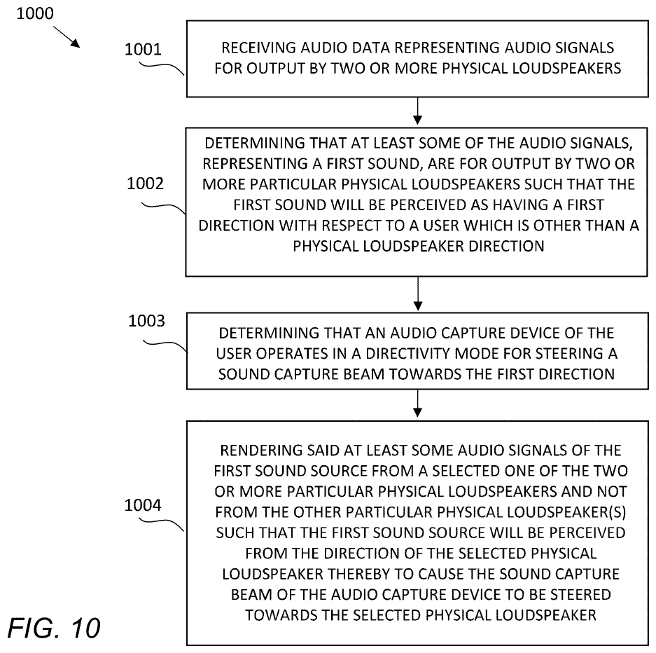

FIG. 10 is a flow diagram showing operations 1000 that may be performed by one or more further example embodiments. The operations 1000 may be performed by hardware, software, firmware or a combination thereof. The operations 1000 may be performed by one, or respective, means, a means being any suitable means such as one or more processors or controllers in combination with computer-readable instructions provided on one or more memories. The operations 1000 may, for example, be performed by the audio processor 502 already described in relation to the above examples.

A first operation 1001 may comprise receiving audio data representing audio signals for output by two or more physical loudspeakers.

A second operation 1002 may comprise determining that at least some of the audio signals, representing a first sound source, are for output by two or more particular physical loudspeakers such that the first sound source will be perceived as having a first direction with respect to a user which is other than a physical loudspeaker direction.

A third operation 1003 may comprise determining that an audio capture device of the user operates in a directivity mode for steering a sound capture beam towards the first direction.

A fourth operation 1004 may comprise, responsive to the second and third determining operations 1002, 1003, rendering said at least some audio signals of the first sound source from a selected one of the two or more particular physical loudspeakers and not from the other particular physical loudspeaker(s) such that the first sound source will be perceived from the direction of the selected physical loudspeaker thereby to cause the sound capture beam of the audio capture device to be steered towards the selected physical loudspeaker.

According to this particular example, the audio processor 502 may render the audio signals of the first sound source differently than was intended according to the received audio data. This may, for example, comprise modifying spatial metadata that is received with the audio data for effectively moving the first sound source to the selected physical loudspeaker.

Referring back to FIG. 5, for example, in accordance with the first operation 1001, audio data may be received by the audio processor 502 in an IVAS bitstream with a specific format including, but not limited to, MASA, OMASA and/or ISM.

In accordance with the second operation 1002, spatial metadata included one of said formats may be analysed by the audio processor 502 in order to determine that at least some of the audio signals, representing the first sound source 200, are for output by the first and third loudspeakers 104A, 104C such that the first sound source will be perceived as having the first direction 202 with respect to a user which is other than a physical loudspeaker direction.

In accordance with the third operation 1003, the audio processor 502 may determine from, for example, a notification message received from the earphone 300, that it is operating in a directivity mode for steering a sound capture beam 506 towards the first direction 202.

In accordance with the fourth operation 1004, the audio processor 502 may render at least some of the audio signals of the first sound source 200 from the first loudspeaker 104A and not from the third loudspeaker 104C such that the first sound source will be perceived from the direction of the first loudspeaker. Alternatively, the audio signals of the first sound source 200 may be rendered from the third loudspeaker 104C and not the first loudspeaker 104A.

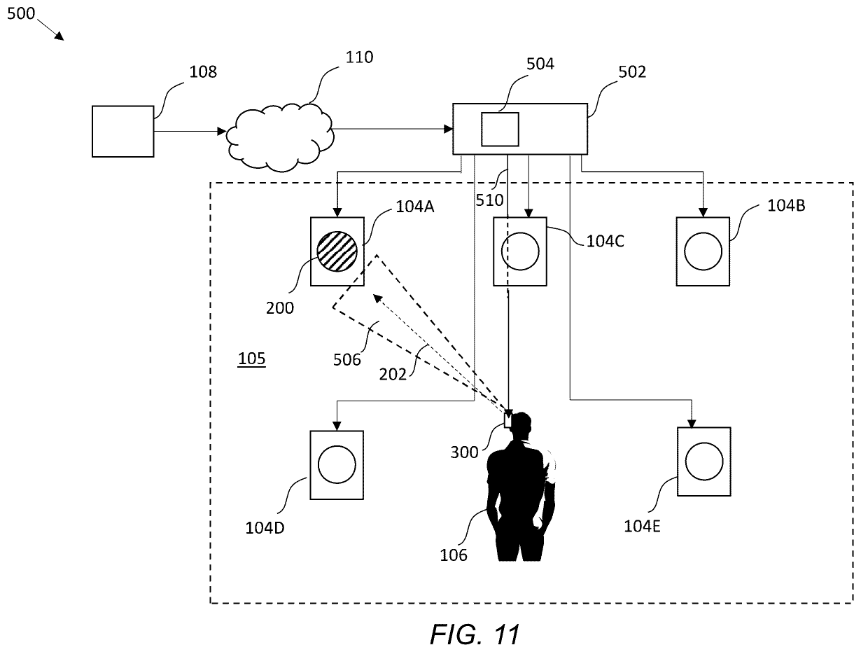

Referring to FIG. 11, this will cause the sound capture beam 506 of the earphone 300 to be steered towards the first loudspeaker 104A.

It will be appreciated from the above that by rendering audio signals of the first sound source 200 from only the first loudspeaker 104A, the user of the earphone 300 will have improved perception of the first sound source.

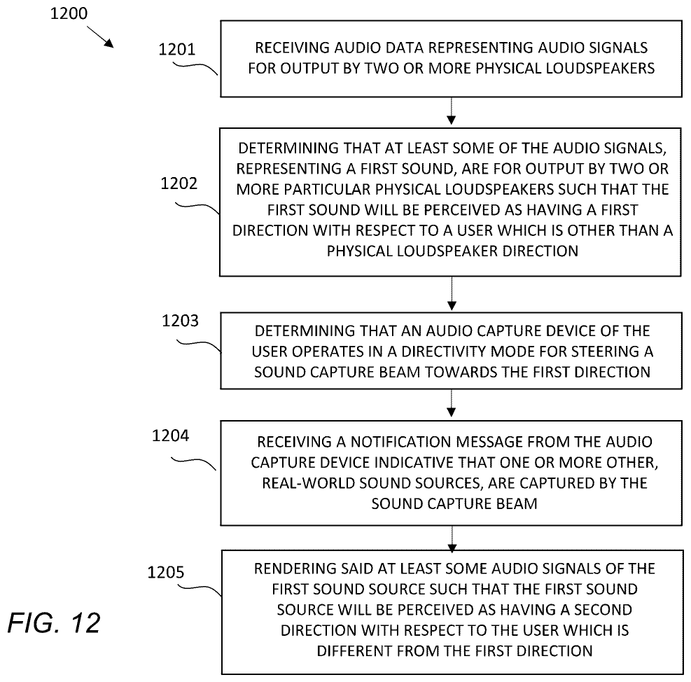

FIG. 12 is a flow diagram showing operations 1200 that may be performed by one or more further example embodiments. The operations 1200 may be performed by hardware, software, firmware or a combination thereof. The operations 1200 may be performed by one, or respective, means, a means being any suitable means such as one or more processors or controllers in combination with computer-readable instructions provided on one or more memories. The operations 1200 may, for example, be performed by the audio processor 502 already described in relation to the above examples.

A first operation 1201 may comprise receiving audio data representing audio signals for output by two or more physical loudspeakers.

A second operation 1202 may comprise determining that at least some of the audio signals, representing a first sound source, are for output by two or more particular physical loudspeakers such that the first sound source will be perceived as having a first direction with respect to a user which is other than a physical loudspeaker direction.

A third operation 1203 may comprise determining that an audio capture device of the user operates in a directivity mode for steering a sound capture beam towards the first direction.

A fourth operation 1204 may comprise receiving from the audio capture device a notification message indicative that one or more other, real-world sound sources, are captured by the sound capture beam.

In some example embodiments, the notification message may be received responsive to user feedback indicating that the first sound source is being masked or interfered with by a real-world sound source. The user feedback may be received as a voice notification or by the user selecting a particular option on the audio capture device or to the audio processor.

A fifth operation 1205 may comprise, responsive to receiving the notification message, rendering said at least some audio signals of the first sound source such that the first sound source will be perceived as having a second direction with respect to the user which is different from the first direction.

The second direction may be at least a predetermined angle with respect to, i.e. away from, the first direction, e.g. at least 25 degrees with respect to the first direction.

This example embodiment may be applicable to the case where the audio capture device is a pair of earphones or headphones and the audio data is for binaural rendering, possibly with head-tracking capability such that audio sources remain static in the audio field represented by the audio data when the user rotates their head. The audio capture device may be operable in a so-called transparency mode whereby sounds from the environment are also captured.

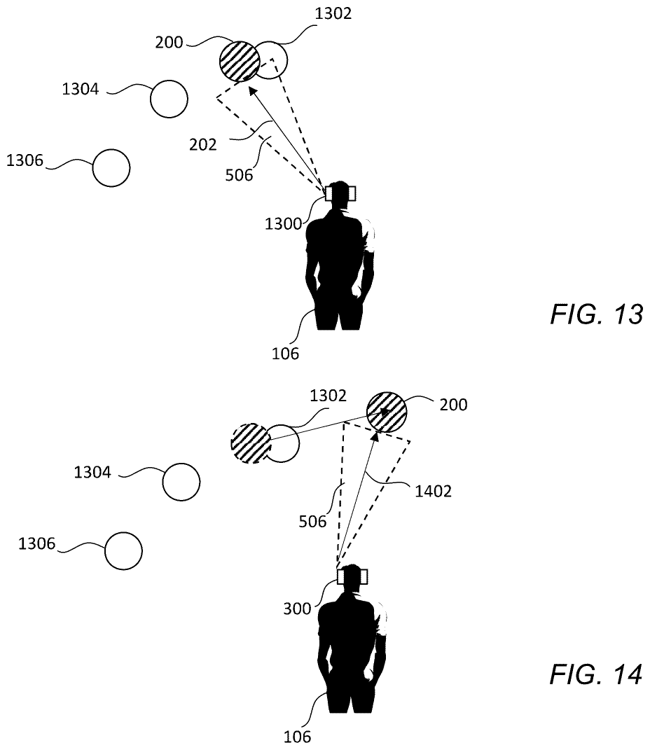

Referring to FIG. 13, the user at position 106 is shown wearing a pair of head-tracking earphones 1300 operable in a directivity mode and a transparency mode. The audio processor 502 and loudspeakers 104A-104E are omitted from FIG. 13 for clarity purposes. FIG. 13 shows an example audio scene comprising the first sound source 200. Within the environment of the user are also first, second and third real-world sound sources 1302, 1304, 1306.

In accordance with the first operation 1201, audio data may be received by the audio processor 502 in an IVAS bitstream with a specific format including, but not limited to, MASA, OMASA and/or ISM.

In accordance with the second operation 1202, spatial metadata included in such formats may be analysed by the audio processor 502 in order to determine that at least some of the audio signals, representing the first sound source 200, are for output by the first and third loudspeakers 104A, 104C such that the first sound source will be perceived as having the first direction 202 with respect to the user which is other than a physical loudspeaker direction.

In accordance with the third operation 1203, the audio processor 502 may determine from, for example, a notification message received from the head-tracking earphones 1300, that it is operating in a directivity mode for steering a sound capture beam 506 towards the first direction 202.

In accordance with the fourth operation 1204, the audio processor 502 may receive a further notification message from the head-tracking earphones 1300 or another user device, indicative that a real-world sound source, in this case the first real-world sound source 1302, is being captured by the sound capture beam 506. For example, the user may select an option on the head-tracking earphones 1300 or on the audio processor 502 to signal that they are experiencing masking effects due to sounds from the first real-world sound source 1302.

In accordance with the fifth operation 1205, and as shown in FIG. 14, the audio processor 502 may render the audio signals of the first sound source 200 such that it will be perceived as having a second direction 1402 with respect to the user.

The audio processor 502 may, for example, modify spatial metadata received with the audio data such as to rotate the direction at which the first sound source 200 will be perceived by 25 degrees. Where the first sound source 200 comprises part of an audio scene comprising a plurality of sound sources, all sound sources may be rotated by the same amount in the same direction.

In this way, the sound capture beam 506 will be steered by the head-tracking earphones towards the second direction 1402 and the masking is reduced or eliminated.

In the above embodiments, it will be noted that the audio data may be received in an IVAS bitstream. In some examples, this may involve negotiating an IVAS session with the remote source 108, for example prior to commencing processing of the audio data, e.g., at the start of an audio call.

As part of this process, the audio processor 502 may preferentially negotiate a particular IVAS sub-format, or a particular order of IVAS sub-formats, based for example on the rendering capabilities of the audio processor 502 and possibly based also on the determination that the audio capture device operates in the directivity mode. The particular IVAS sub-formats may include, but are not limited to, MASA, OMASA and/or ISM.

For example, the audio processor 502 may receive from the remote source 108 a session description protocol, SDP, message which may appear as follows:
m=audio 49152 RTP/AVP 96
a=rtpmap: 96 IVAS/16000
a=fmtp: 96 inf=9, 21-24, 10-13;
a=ptime: 20
a=maxptime: 240
a=sendonly
   where inf indicates the IVAS input format capability.

The inf parameter can have a value from a set comprising 1-24. In the case that a range of input formats is supported, it is indicated by the first input format in the range and the last in the range separated by a hyphen (inf1−inf2).

In the case of multiple input formats that are not a contiguous range, but individual formats, those may be listed as comma separated values (inf1, inf2). Comma separated values are also used, when the input formats are within a range, but the preferred order of the formats is not the default contiguous range.

In both cases, i.e. a hyphen or comma separated list, the input formats are listed in a preferred order from the most preferred to the least preferred input format. Parameters inf-send and inf-recv are used in case where different input formats are used in both the send and receive directions respectively. If the inf parameter is not present, all possible IVAS input formats are supported for the session.

The IVAS input formats and their assigned inf attribute values are:

| IVAS Input Format | Attribute Inf Value |
|---|---|
| Mono | 1 |
| Stereo | 2 |
| Binaural | 3 |
| Multichannel (5.1, 7.2, 5.1.2, 5.1.4 | 4-8 |
| 7.1.4) | |
| MASA | 9 |
| ISM (1, 2, 3, 4 objects) | 10-13 |
| SMA (FOA, HOA2, HOA3) | 14-16 |
| OMASA (1, 2, 3, 4 objects) | 17-20 |
| OSBA (1, 2, 3, 4 objects) | 21-24) |

Accordingly, in respect of embodiments described above in relation to the audio processor 502, further operations may comprise, responsive to detecting that the audio data and spatial metadata is received in an IVAS bitstream, identifying that one or more of the MASA, OMASA and ISM data formats is or are supported by the IVAS bitstream and selecting one, or a preferential order, of the MASA, OMASA and ISM data formats for decoding of the IVAS bitstream and obtaining the spatial metadata for decoding using an appropriate decoder. The selection may be based on which data formats are supported by the audio processor 502.

### Example Apparatus

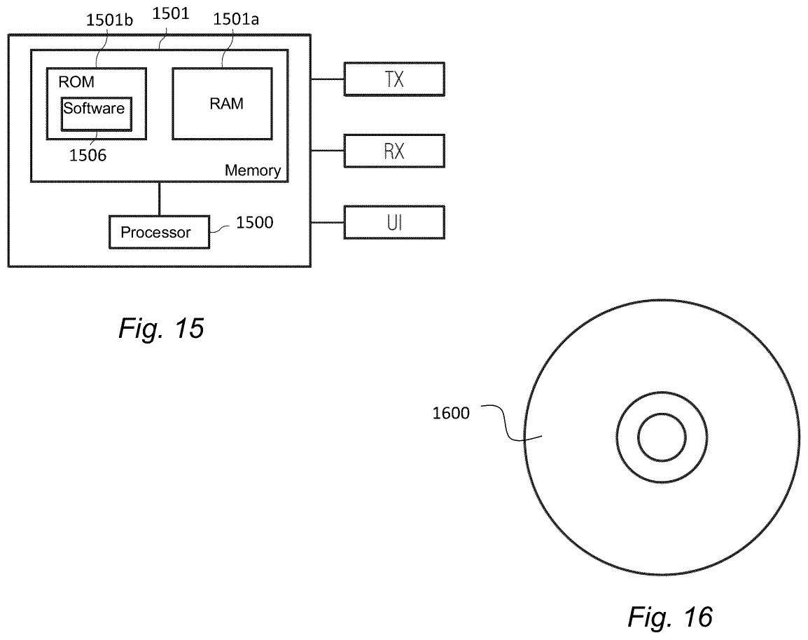

FIG. 15 shows an apparatus according to some example embodiments. The apparatus may be configured to perform the operations described herein, for example operations described with reference to any disclosed process. The apparatus comprises at least one processor 1500 and at least one memory 1501 directly or closely connected to the processor. The memory 1501 includes at least one random access memory (RAM) 1501a and at least one read-only memory (ROM) 1501b. Computer program code (software) 1506 is stored in the ROM 1501b. The apparatus may be connected to a transmitter (TX) and a receiver (RX). The apparatus may, optionally, be connected with a user interface (UI) for instructing the apparatus and/or for outputting data. The at least one processor 1500, with the at least one memory 1501 and the computer program code 1506 are arranged to cause the apparatus to at least perform at least the method according to any preceding process, for example as disclosed in relation to any flow diagram described herein and related features thereof.

FIG. 16 shows a non-transitory media 1600 according to some embodiments. The non-transitory media 1600 is a computer readable storage medium. It may be e.g. a CD, a DVD, a USB stick, a blue ray disk, etc. The non-transitory media 1600 stores computer program instructions, causing an apparatus to perform the method of any preceding process for example as disclosed in relation to any flow diagram described and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi. A memory may be volatile or non-volatile. It may be e.g. a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-24. (canceled)

25. An apparatus, comprising:
at least one processor; and
at least one memory storing instructions that, when executed by the at least one processor,
cause the apparatus at least to:
receive audio data representing audio signals for output by two or more physical loudspeakers;
determine that at least some of the audio signals, representing a first sound source, are for output by two or more particular physical loudspeakers such that the first sound source will be perceived as having a first direction with respect to a user which is other than a physical loudspeaker direction; and
responsive to the determining, transmit control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

26. The apparatus of claim 25, wherein the apparatus is further caused to:
receive a notification message from the audio capture device for indicating that the audio capture device is operating in the directivity mode, and
wherein the control data is transmitted to the audio capture device in further response to receiving the notification message.

27. The apparatus of claim 25, wherein the control data is for causing the audio capture device to widen the sound capture beam such that it has greater sensitivity to audio signals from a wider range of directions with respect to the user, including the direction of the at least one of the two or more particular physical loudspeakers.

28. The apparatus of claim 27, wherein the control data is for causing the audio capture device to widen the sound capture beam such that it has greater sensitivity to audio signals from respective directions of the two or more particular physical loudspeakers.

29. The apparatus of claim 25, wherein the control data is for causing the audio capture device to steer the sound capture beam from the first direction to the direction of one of the two or more particular physical loudspeakers.

30. The apparatus of claim 27, wherein the control data comprises data indicative of a spatial position of at least one of the two or more particular physical loudspeakers for enabling the audio capture device to estimate the direction or respective directions of the at least one of the two or more particular physical loudspeakers.

31. The apparatus of claim 27, wherein the apparatus is further caused to:
receive, from the audio capture device, position data indicative of its spatial position and direction of the sound capture beam; and
determine a modification to apply to the sound capture beam of the audio capture device using the position data and known position of the at least one of the two or more particular physical loudspeakers,
wherein the control data comprises the determined modification to be applied by the audio capture device.

32. The apparatus of claim 25, wherein the apparatus is further caused to:
receive spatial metadata associated with the audio data, the spatial metadata indicating spatial characteristics of an audio scene which comprises at least the first sound source; and
determine from the spatial metadata that the first sound source will be perceived as having said first direction with respect to the user which is other than a physical loudspeaker direction.

33. The apparatus of claim 32, wherein the audio data and spatial metadata is received in an Immersive Voice and Audio Services, IVAS, bitstream.

34. The apparatus of claim 33, wherein the IVAS bitstream comprises at least of one of:
Metadata-Assisted Spatial Audio, MASA;
Objects with Metadata-Assisted Spatial Audio, OMASA; or
Independent Streams with Metadata, ISM.

35. The apparatus of claim 25, comprising a mobile terminal.

36. An apparatus, comprising:
at least one processor; and
at least one memory storing instructions that, when executed by the at least one processor,
cause the apparatus at least to:
capture audio signals output by two or more physical loudspeakers, including audio signals representing a first sound source output by two or more particular physical loudspeakers such that the first sound source will be perceived as having a first direction with respect to a user which is other than a physical loudspeaker direction;
operate in a directivity mode for steering a sound capture beam towards the first direction; and
receive control data from a control device, wherein the control data causes disabling of the directivity mode or modifying of the sound capture beam such that the apparatus has greater sensitivity to audio signals from the direction of at least one of the two or more particular physical loudspeakers.

37. The apparatus of claim 36, wherein the apparatus is further caused to:
transmit a notification message to the control device for indicating that the apparatus is operating in the directivity mode, and
wherein the control data is received from the control device in response to transmitting the notification message.

38. The apparatus of claim 36, wherein the control data causes widening of the sound capture beam such that it has greater sensitivity to audio signals from a wider range of directions, including the direction of the at least one of the two or more particular physical loudspeakers.

39. The apparatus of claim 38, wherein the control data causes widening of the sound capture beam such that it has greater sensitivity to audio signals from respective directions of the two or more particular physical loudspeakers.

40. The apparatus of claim 36, wherein the control data causes the sound capture beam to be steered from the first direction to the direction of one of the two or more particular physical loudspeakers.

41. The apparatus of claim 38, wherein
the control data comprises data indicative of a spatial position of the at least one of the two or more physical loudspeakers, and
the apparatus is further caused to estimate the direction or respective directions of the at least one of the two or more particular physical loudspeakers.

42. The apparatus of claim 38, wherein the apparatus is further caused to:
transmit, to the control device, position data indicative of a spatial position of the apparatus and the direction of the sound capture beam;
wherein the control data comprises a determined modification to apply to the sound capture beam based on the position data and known position(s) of the at least one of the two or more particular physical loudspeakers.

43. A method, comprising:
receiving audio data representing audio signals for output by two or more physical loudspeakers;
determining that at least some of the audio signals, representing a first sound source, are for output by two or more particular physical loudspeakers such that the first sound source will be perceived as having a first direction with respect to a user which is other than a physical loudspeaker direction; and
responsive to the determining, transmitting control data to an audio capture device of the user which operates in a directivity mode for steering a sound capture beam towards the first direction, wherein the control data is for causing the audio capture device to disable its directivity mode or to modify the sound capture beam such that the audio capture device has greater sensitivity to audio signals from the direction of at least one of the two or more particular physical loudspeakers.

44. The method of claim 43, further comprising:
receiving a notification message from the audio capture device for indicating that the audio capture device is operating in the directivity mode, and
wherein the control data is transmitted to the audio capture device in further response to receiving the notification message.
